(19) United States
(12) Patent Application Publication
(10) Pub. No.: US 2008/0140828 A1
(43) Pub. Date: Jun. 12, 2008

(54) Method And System For Control And Registration Of Personnel Movement Between Any Number Of Points

(76) Inventors: Ryszard Kalinski, Ozarow Mazowiecki (PL); Piotr Reszczyk, Wesola (PL); Krzystof Stalewski, Warszawa (PL)

Correspondence Address: MATTHIAS SCHOLL, 14781 MEMORIAL DRIVE, SUITE 1319, HOUSTON, TX, 77079, US

(21) Appl. No.: 11/721,814

(22) PCT Filed: Dec. 15, 2005
(86) PCT No.: PCT/PL05/00082

§ 371 Date: Jun. 15, 2007

(30) Foreign Application Priority Data
Dec. 16, 2004 (PL) P.371778

(51) Int. Cl. G06F 15/16

(52) U.S. Cl. 709/224

(57) ABSTRACT

A method of control and registration of a movement of personnel between any number of points according to invention is provided wherein during the movement, the personnel reads data referring to at least one control point, when they reach the control point, and then sends data at least referring to one control point to the supervising station by electromagnetic waves. Advantageously, data transmitted comprises data referring to the control point along with other data, e.g. data identifying the personnel reading the data of the control point. A system for control and registration of a movement of personnel between any number of control points comprises at least one control point (PK), a mobile registration unit (RJ) as the personnel equipment, and a supervising station (SN), wherein according to the invention the registration unit (RJ) comprises a receiver block (BO), a control block (BS), and a transmitter block (BN); the receiver block (BO) comprises an identification unit (UI), the control block (BS) comprises an information analysis system (UA, the transmitter block (BN) comprises a data transmission unit (UT), and the supervising station (SN) comprises an analysis and identification unit (UAI).

### CROSS-REFERENCE TO RELATED APPLICATIONS

This is a National Stage Application of International Patent Application No. PCT/PL 2005/000082, with an international filing date of Dec. 15, 2005, which is based on Polish Patent Application No. P.371778, filed Dec. 16, 2004. The contents of both of these specifications are incorporated herein by reference.

### BACKGROUND OF THE INVENTION

1. Field of the Invention

The invention relates to a method for control and registration of personnel movement between any number of points, and to a system for control and registration of personnel movement between any number of points. More specifically, the invention relates to an active control of rounds in secured facilities by security guards, active control of the work of janitors, mailmen, drivers, maintenance service employees, maintenance technicians, patrol teams, city guards, persons distributing keys or borrowed objects, employees of museums, forest guards, etc.

2. Description of the Related Art

One method of control of staff movement in underground mines based on reception of signals from mobile ID modules is described in Polish Pat. App. No. 187 278. This method is based on reception of signals from mobile ID modules carried by miners. The signals are received by an identifying station, and transmitted to a control station. The signals in a given ID station are received and processed by two identifying gates, located near each other. Each gate rejects weak signals, checks the correctness of each signal, and measures the time of signal reception and signal intensity. Then, the time of entry and intensity of the initial signal as well as the time of entry and intensity of the final signal received from the mobile ID module, i.e., from the specified object—the miner, are registered. The values are transmitted to the control station, where the cyclic information from both gates is collected and based on the time and intensity of the initial and final receptions, using a special algorithm, a list is generated, comprising information about the movement direction of all mobile ID modules within the controlled zone.

The weakness of this system involves the need for two gates at each ID station, with identical electronic systems and separate antennas, which increases the costs of installation. Additionally, the identification of an object in the vicinity of the gates is first performed at the control station by analysis of the signals received. Since the gates at the ID station may reject weak signals as being due to a large distance and not caused, e.g., by an exhausted ID module power source, and the formal correctness of each signal, and intensity of the initial and final signal received from the mobile ID module to the gates of the ID station, and then the received values from each gate of the ID station is sent to the control station, this may also cause errors in signal analysis in relation to a possibility of disturbances in signal transmission from the ID station to the control station.

It is also possible for the object passing near the gates and not through the gates to be registered. The aforesaid circumstances result in a lack of possibility of unambiguous specification of the object location. The disadvantages also include the cyclic manner of signal transmission by the ID module and cyclic collection of information from the control station gates. Thus, the system is highly unreliable and does not provide unambiguous information about the location of the controlled object, as well in case of open space or rooms with a large number of electric installations, it is highly sensitive to disturbances.

It is also known a control system SEVEN GUARD manufactured by Przedsiehiorstwo Specjalistyczne SYSTEM 7 SECURITY, Biefsko Biala, allowing for registration of work of guards, janitors, mailmen, maintenance service employees, maintenance technicians, patrol teams, city guards, persons distributing keys or borrowed objects, etc. The main element of the system is the SEVEN GUARD 2 registration unit. A person equipped with the registration device “records” the actual course of his/her professional duties. The registration device remembers events involving reading of the control points, which may have specified importance assigned, e.g., the fact of staying in a specified place, occurrence of certain event, release/receipt of the key or equipment, etc. Additionally, other system events are recorded, necessary for ensuring the effectiveness of the system, e.g. high or low temperature, low voltage of the battery, change in the clock settings, unnecessary charging, etc.

The registration device may be given any name and a unique number, which allows for easy identification of the device and events registered by it. It is possible to use one registration device by several persons. SEVEN GUARD 2 registration unit may cooperate with a computer, or directly with a printer, via a docking station and an adequate connecting cable. It is possible to use all basic system functions without the use of a computer but only with the docking station and the printer. However, using the computer allows for a full utilization of the large possibilities of the registration unit. It also allows for building of central (global) or independent control systems using, e.g., e-mail for data transmission.

Work supervisors may at any time quickly check the time at each location of the registration unit user—and a performed task— or check the mistakes that each user made in his/her work, and determine where and when he/she should be according to the schedule, and which of the tasks entrusted were not realized correctly. However, the necessary and absolute condition of the control performance is the return of the registration unit by the controlled person, and printing or reading of data via a computer. Therefore, it should be emphasized that the ongoing control of the personnel work or obtaining information about any irregularities during work performance is not possible with this system. Information obtained is useful only from a statistical point of view and for accounting of working hours and discipline. After the return of a registration unit, the control is delayed by at least the time during which the unit holder is on duty, or alternatively, by time that a supervising person with a computer or printer can reach the unit user.

The basic disadvantages of the aforementioned control methods and systems involve the fact that information, e.g. referring to the proper round of the guards in the facility, is obtained some time after a round has been made, and not in real time, which means that the persons supervising guards securing such, facilities, as halls, buildings, etc., do not know whether a guard made his/her rounds of the entire facility, or only of certain points thereof.

There may be situations, in which unauthorized persons may enter the secured zone in a place, which the guard has not yet reached, or passed by it, and information about such events will only be known later, e.g., after the company employees have come to work in the morning. Checking the correctness of work performed by the controlled persons and their keeping to the schedule is possible either after the analysis of information coming from the control points to the computer through the network and confirming which control points the guard has reached, or after delivery of the registration unit and making adequate printouts, or after reading the data downloaded by the registration unit by a computer and processing by an adequate software, and their display on a monitor or printer.

Additionally, the disadvantages of the known methods and equipment include their complicated structure and the sensitivity to damage of the lines connecting the supervising computer with the control points in case that the information is transmitted from the control points or gates to the main computer via a network or phone lines or optic cables.

Thus, the aim of the invention is to develop a method of real, time control of moving objects, i.e., controlled employees. It is a further aim of the invention to build a system for real time control of moving objects, i.e., controlled employees.

### BRIEF SUMMARY OF THE INVENTION

The aim has been achieved by the development of a method of control and registration of personnel movement, between any number of points, involving the following procedure: during movement, the personnel reads data referring to at least one control point after reaching that control point, and then sends the data referring to at least that control point to the supervising station by electromagnetic waves,

Advantageously, the data transmitted comprises data referring to at least one control point and other data.

Advantageously the data transmitted comprises data referring to at least one control point and data identifying the personnel reading the data at the control point.

Advantageously, the data referring to the control point and data identifying the reading personnel are collated with data, referring to the date and hour of reading being taken by the personnel, and then the collated data is transmitted to the supervising station by electromagnetic waves.

Advantageously the data, referring to individual control points are read when the personnel are present within a direct range of the control point.

Advantageously, the data is transmitted to a supervising station in real time following each data reading occurrence by the personnel at a control point.

Advantageously, the data is transmitted to the supervising station with a specified delay time following each reading of the control point data by the reading personnel.

Advantageously, the data referring to an individual control point is read by electromagnetic waves.

Advantageously, the data referring to an individual control point is read by light waves.

Advantageously, the data referring to an individual control point is read by sound waves.

Advantageously, the data referring to an individual control point is read by direct connection with the control point via a connector.

The aim of the invention was also achieved by building of a system for control and registration of personnel movement between any number of control points, having at least one control point, a mobile registration unit as the personnel equipment and a supervising station, in which according to invention the registration unit comprises a receiver block, a control block and a transmitter block, and the receiver block comprises an identification unit of the control points for reading the identification data of individual control points, the control block comprises an information analysis system, the transmitter block comprises a data transmission unit for sending data to the supervising station, and the supervising station comprises an analysis and identification unit for analysis and identification of signals corning from the registration units.

Advantageously, the control block comprises an information analysis system for collating data from the individual control points with data identifying the registration unit.

Advantageously, the control block comprises an information analysis system for collating data from the individual control points with data referring to the date and time of data reading at the control point.

Advantageously, the control block comprises an information analysis system, for collating data from the individual control points with data Identifying the registration unit and with data referring to date and time of data reading at the control point.

Advantageously, the transmitter block comprises data transmission unit for sending data to the supervising station in real time, each time after reading and collating and/or comparing data received from the control point.

Advantageously, the transmitter block comprises data transmission unit for sending data to the supervising station with the specified delay time from the time of reading and collating and/or comparing data received from the control point.

Advantageously, the receiver block comprises an identification unit for reading identification data of individual control points using electromagnetic waves.

Advantageously, the receiver block comprises an identification unit for reading identification data of individual control points using light waves.

Advantageously, the receiver block comprises an identification unit for reading identification data of individual control points using sound waves.

Advantageously, the receiver block comprises an identification unit for reading identification data of individual control points by direct connection of the registration unit with the control point by connectors.

According to the invention, the method and the system allow for cheap and quick construction of the system controlling the moving objects, e.g., employees. Because it is enough to distribute any required number of control points having simple structure in any places, the points may be without their own power source and without connection to the network or to the control station through such network.

Additionally, according to the invention, the method and the system allows for active control of moving of employees, e.g. patrols, etc. within a secured area, wherein the control station compares signals received from individual registration units with the schedule of rounds in an individual area by guards equipped with the registration units, and in case of absence of receiving signals from guards at a specified time, there is the option of immediate checking of why the guard failed to reach a given control point.

### BRIEF DESCRIPTION OF THE DRAWINGS

The objects and advantages of the present invention will become more readily apparent after reading the ensuing description of the non-limiting illustrative embodiment and viewing the accompanying drawings, in which

FIG. 1 shows a block diagram illustrating a system for registration of moving objects of one embodiment of the invention.

### DETAILED DESCRIPTION OF THE INVENTION

The method according to the invention involves reading of signals from control points, and more specifically, from at least one control point, when personnel move along a controlled area, e.g. a building, an exhibition hall, a construction site, a range, etc. After reading, the signals comprising data identifying a given control point are sent to a supervising station, using electromagnetic waves.

According to the method of the invention, other data may be transmitted additionally, such as data identifying the personnel reading information at the control point and/or referring to the date and the precise time information at which information is read by the personnel. Data referring to the individual control points is read when the personnel reading data is present with the registration unit in a direct range of the control point. This solution is aimed at a precise personnel control and at ensuring that an employee cannot misrepresent the fact of not being present at a given point,

Data read is transmitted to the supervising station in real time, each time after being read by the reading personnel, and/or with a predetermined delay counted from the time of data being read by the personnel. Data about the individual control points is read using electromagnetic, light, or sound waves or through direct connection of the registration unit with the control point via connectors.

Reading of control signals is performed in the following manner: a person equipped with a registration unit approaches the control point and places the registration unit in a position allowing for reading of data only from this particular control point. The supervising station analyzes incoming data on an ongoing basis, and on the basis of the schedule of rounds recorded in the station appropriate actions are taken, e.g., if a signal from a given control point specified in the schedule is not received exactly at a certain time interval from, the time of the last reading, an alarm is activated and an adequate communication appears on a computer display. Based thereon, a supervisor can make an adequate decision, e.g., to connect with the personnel on round, or in case of no answer received, to send a checking patrol into the appropriate area. In the case when the signal from the registration unit comes from a different check point than it is set out in the schedule, personnel supervisor also receives an alarm signal and an adequate message, and may promptly direct the personnel to the omitted control point. Therefore, prompt reaction of persons supervising guards is possible.

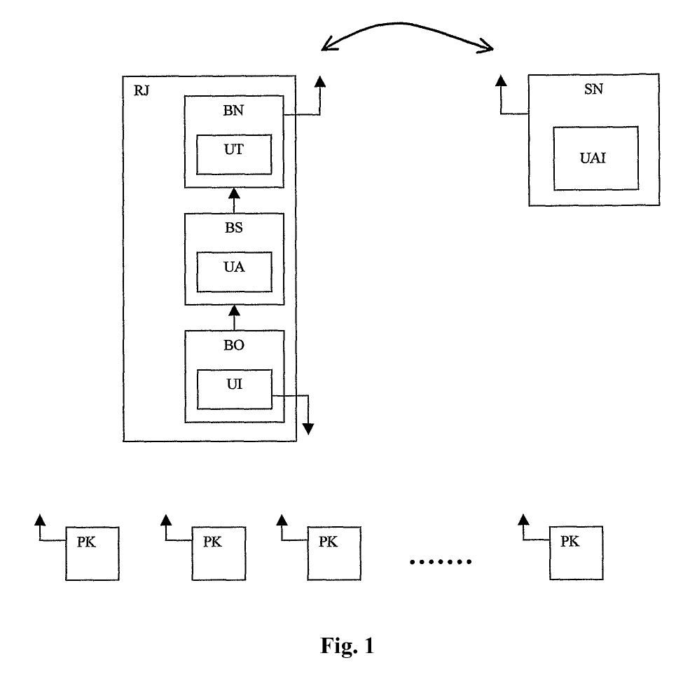

With reference to FIG. 1, the system of control and registration of moving objects according to invention comprises any number of control points PK, any number of mobile registration units RJ, the mobile registration units being individual equipment of moving personnel, e.g. guards, and a supervising station SN. The registration unit RJ comprises a receiver block BO, a control block BS, and a transmitter block BN. The receiver block BO comprises an identification unit Ul of a control point FK for reading Identification data, of the individual control point PK. The control block BS comprises an information analysis system UA for analyzing data from the individual control point FK. The transmitter block BN comprises a data transmission system UT for sending data in real time, just after being read, to the supervising station SN.

The supervising station SN comprises an analysis and identification system UAI for analysis and identification of signals received from the registration unit RJ. The analysis system UA of the control block may also compare and/or collate data from the individual control point PK with the data identifying the registration unit RJ and/or the data identifying the personnel handling the given registration unit, and/or with data referring to the date and precise time of the information reading at the control point PK, and/or with any other data that is to be obtained. The identification unit. UI of the control points PK for reading the identification data of individual control points FK reads data by way of electromagnetic, light, and/or sound waves, or by way of direct connection between the registration unit RJ with the control point FK via connectors.

Since the system of the invention uses registration units RJ to provide data from the control point PK directly by electromagnetic waves to the supervising station SN, therefore, no network connecting the individual control points PK with the supervising station SN is required to be built, which significantly simplifies and speeds up the system construction, reduces costs of the system activation by elimination of the network building costs and their limitation to the assembly costs of the control points PK in the area, and speeds up system, activation.

The system according to invention uses control points PK with their own power sources, or without such power sources; therefore, it is possible to use fixed control points of durable, solid structure, resistant to the atmospheric conditions, mounted by e.g. screws, bolts, rivets, to any surface, such as concrete, wood, sheet metal, etc. After mounting of the control point, the screws or bolts may be secured or filed off in a way to prevent disassembly. Control points PK may also be mounted on surfaces by means of adhesive, e.g., to the assembly sheet metal, bolted to any surface such as concrete, wood, sheet metal, etc. it is also possible to use control points built into a wall structure or concrete, or cemented in with cement mortar. The surface of the connectors should form one plane with the surface in which the control point has been mounted. After drying the mortar, a built into a wall control point PK is in practice indestructible and has the highest mechanical resistance to damage of all control points discussed herein. Usage of control points of simple and solid structure, without having own power supply sources additionally reduces the costs of the system construction, because there is no maintenance needed, i.e., no checks of the correctness of the power supply sources and no replacement in case of their exhaustion.

Absence of the network of cables connecting individual control points PK with the supervising station SN is an additional advantage, because it eliminates the need of network maintenance and repairs during operation, and eliminates the possibility of purposeful damage of the network by third parties interested in getting inside the protected area. It also eliminates actions of the personnel aimed at damaging the network to avoid precise control of their work.

It is obvious that the presented construction solutions do not restrict the essence of the invention and constitute only an example of a solution. The method and the system of the invention allows for active control of the movement of moving objects. The absence of signal from the registration unit within the specified period of time allows for immediate intervention of the personnel supervising the contact with the employee to ascertain reasons of his/her failure to reach the relevant control point or, in case of no answer from, the employee, sending intervention personnel to check on why an employee failed to respond.

The method and the system according to the invention are used mainly to control guards walking rounds in protected buildings, complexes of buildings, and industrial or exhibition areas. The method and the system may also be used to control the movement of mining teams, or personnel checking chemical installations, power supply lines, or other technological installations requiring such periodical controls. It is also possible to apply the system as control of the forest guards walking in forest complexes, museum employees controlling the exhibitions, or installations providing appropriate climatic conditions in the rooms, archives, etc.

Having such system and method, one may always be sure that the personnel reached a specified control point, because he/she must read the data specific only to that point and send it to she supervising station, and not, e.g., inform the supervising personnel, e.g. by radio, that he/she has reached a given point since this may be done without actually reaching a control point. Additionally, it is assured that supervisors are familiar with the situation around the control point, and may react without a delay in case of any problems, by contacting with the personnel through other means, such as by mobile phones or portable radio transmitters.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

1-21. (canceled)

22. A method for control and registration of a movement of personnel between any number of points, comprising the steps of:
(a) reading data identifying a control point after reaching the control point; and
(b) sending at least data identifying a control point to a supervising station by electromagnetic waves.

23. The method of claim 22, further comprising sending other data together with data, identifying a control point.

24. The method of claim 23, wherein the other data comprises data identifying personnel that has performed the reading of data identifying a control point.

25. The method of claim 22, further comprising
collating data identifying a control point and data identifying personnel that has performed reading data identifying a control point with data, referring to the date and hour of when the reading of data identifying a control point was performed; and
sending the collated data to a supervising station by electromagnetic waves

26. The method of claim 22, wherein data identifying a control point is read when the personnel are present within a direct range of the control point.

27. The method of claim 22, wherein data is transmitted to the supervising station in real time immediately after reading data identifying a control point.

28. The method of claim 22, wherein data is transmitted to the supervising station within a specific delay after reading data identifying a control point.

29. The method of claim 22, wherein reading of data occurs by electromagnetic waves.

30. The method of claim. 22, wherein reading of data occurs by light waves or sound waves.

31. The method of claim 22, wherein reading of data occurs through a direct connection with the control point by a connector.

32. A system for control and registration of a movement of personnel between any number of control points (PK), comprising
at least one control point (PK);
at least one mobile registration unit (RJ) comprising a receiver block (BO); a control block (BS), and a transmitter block (BN); and
a supervising station (SN), wherein
said receiver block (BO) comprises an identification unit (UI) for reading the identification data of an individual control point (PK);
said control block (BS) comprises an information analysis system (UA);
said transmitter block (BN) comprises a data transmission unit (UT) for sending data to the supervising station (SN); and
said supervising station (SN) comprises an analysis and identification unit (UAI) for analysis and identification of signals received from said mobile registration unit (RJ).

33. The system of claim 32, wherein said information analysis system (UA) collates data from at least one said control point (PK) with data identifying said registration unit (RJ).

34. The system of claim 33, wherein said information analysis system (UA) collates data from at least one said control point (PK) with data referring to date and time of reading data identifying at least one said control point (PK).

35. The system of claim 32, wherein said information analysis system (UA) collates data from at least one said control point (PK) with data identifying said registration unit (RJ) and with data referring to date and time of reading data identifying at least one said control point (PK).

36. The system of claim 32, wherein said data transmission, unit (UT) sends data to said supervising station (SN) in real time.

37. The system of claim 32, wherein said data transmission unit (UT) sends data to said supervising station (SN) after a specified delay time,

38. The system of claim 32, wherein said identification unit (UL) reads identification data of at least one said control point (PK) using electromagnetic waves.

39. The system, of claim 32, wherein said identification unit (UL) reads identification data of at least one said control point (PK) using light waves or sound waves.

40. The system, of claim 32, wherein said identification unit (UI) reads identification data from at least one said control point (PK) by direct connection of the registration unit (RJ) with, the control point (PK) by a connector.

41. A method for control and registration of a movement of personnel between any number of points, comprising the steps of:
(a) providing the system, of claim 32;
(b) reading data referring to at least one said control point after reaching said control point; and
(c) sending at least data referring to said control point to said supervising station by electromagnetic waves.
